(19) United States
(12) Patent Application Publication
(10) Pub. No.: US 2014/0303755 A1
(43) Pub. Date: Oct. 9, 2014

(54) Machine, Computer Program Product for a Data-Display Device, and Method for Monitoring the Status of a Machine

(71) Applicant: Robert Bosch GmbH, Stuttgart (DE)

(72) Inventors: Guenther Landgraf, Karlstadt-Karlburg (DE); Holger Schnabel, Wuerzburg (DE); Stephan Schultze, Lohr-Wombach (DE)

(73) Assignee: Robert Bosch GmbH, Stuttgart (DE)

(21) Appl. No.: 14/244,706

(22) Filed: Apr. 3, 2014

(30) Foreign Application Priority Data
Apr. 5, 2013 (DE) 10 2013 005 769.8

(51) Int. Cl. G05B 19/048; G05B 19/418

(52) U.S. Cl. CPC G05B 19/048; G05B 19/41855; G05B 2219/14006; G05B 2219/1133
USPC 700/83

(57) ABSTRACT

A machine includes an electrical controller, a provider unit, and a communications device. The electrical controller is configured to control the machine and/or at least one element of the machine. The provider unit is configured to provide a mobile data-display device with data relating to a status of the machine and/or a status of the at least one element controlled by the electrical controller. The communications device is configured for wireless communication with the mobile data-display device. The provider unit is further configured such that in response to a request received by the communications device from the mobile data-display device, the provider unit provides data currently being requested so that the mobile data-display device can read and display the provided data in real time.

This application claims priority under 35 U.S.C. §119 to patent application no. DE 10 2013 005 769.8, filed on Apr. 5, 2013 in Germany, the disclosure of which is incorporated herein by reference in its entirety.

The present disclosure relates to a machine, a computer program product for a data-display device, and a method for monitoring the status of a machine and/or of at least one element of said machine.

### BACKGROUND

In the field of machines such as processing machines, in particular packaging machines, printing machines etc., and machine tools, the topic of condition monitoring or status monitoring of components, devices or machines is becoming increasingly important. This is why possible ways are being sought to display easily, for instance for a machine operator, the status of the components, the devices or the machine according to specific aspects.

A comparative trend of a status of a machine component can be obtained, for instance, by monitoring load cycles or individual parameters with respect to defined limits, as proposed for example by the VDMA, the German Engineering Association, in its recommendation on status monitoring (condition monitoring), and the relevant condition can be generated. Load cycles may be, for instance, number of parts produced, number of operating hours, etc. Parameters may be, for instance, temperature of a drive or temperature of a process, mean torque curve for a drive, closure time of a gripping mechanism, etc. Another monitoring option involves, for example, using specific sensors such as vibration sensors, compressing the raw data from said sensors, for example acceleration over time, etc., into one or more characteristic parameters, and then in turn determining the status using definable limits.

For displaying the status, for instance, it is possible to provide permanently installed display screens at a central point, for example on a central computer. This is a reasonable option for a small machine that the machine operator can see clearly in full. This option is a problem, however, for a machine in which a multiplicity of machine components are installed in a production hall, as is the case, for instance, with a packaging machine, printing machine or an assembly line. For such machines, there is an increasing requirement for the machine operator also to be able to determine the status close to the individual machine components. This would result in a multiplicity of expensive display screens, for instance at every single machine element or module of the machine, with the installation and necessary maintenance of such display screens generating additional costs.

A further problem lies in the fact that at present it is not easily possible to be able to display the status information from all the machines in a production hall. Therefore an economic solution to this problem is required that can be handled easily and effectively by a machine operator.

### SUMMARY

The object of the present disclosure is therefore to provide a machine, a computer program product for a data-display device, and a method for monitoring the status of a machine and/or of at least one element of said machine, by means of which the aforementioned problems can be solved. In particular, a machine, a computer program product for a data-display device and a method for monitoring the status of a machine and/or of at least one element of said machine shall be provided that enable easy and economic visualization and processing of the status of a machine or a load.

This object is achieved by a machine as described herein. The machine comprises an electrical controller for controlling the machine and/or at least one element thereof, a provider unit for providing a mobile data-display device with data relating to the status of the machine and/or of at least one of the elements controlled by the electrical controller, and a communications device for wireless communication with the mobile data-display device, wherein the provider unit is designed such that in response to a request received by the communications device from the mobile data-display device, it provides the data currently being requested so that the mobile data-display device can read and display the provided data in real time.

At the machine, the status of the machine or of another load can be visualized and processed easily using a mobile device. For instance, the mobile device can be a smartphone, tablet PC or another device that can be connected wirelessly to a machine. The status can thereby be visualized easily, wirelessly and in a mobile manner. A mobile device can be used in any locations, which is a major advantage particularly in a large production hall. In particular, the mobile device can replace a central visualization device and/or all the visualization devices arranged locally at the individual machine elements, which devices are used for configuring the machine, dealing with a servicing job, displaying the current production status or other machine conditions, for diagnostic analyses etc.

Using mobile devices such as a smartphone, tablet PC etc., for example, with the machine is now also possible in automation engineering. This means that the conventional wired human machine interfaces, also known as HMIs for short, are no longer required. Not only does this dispense with the installation costs of wired HMIs but it also reduces the risk of accidents from any trailing or exposed cables.

The dependent claims contain advantageous further embodiments of the device.

The provider unit is preferably designed to collect data from different levels of the machine relating to the status of the machine and/or of at least one of the elements controlled by the electrical controller. In addition to the local display of an individual machine and the elements thereof, this also enables status information across different levels of a single machine to be grouped together or displayed jointly. The different levels may be, for example, the level for sensors, the higher-level intelligent-drives level, etc.

It is possible that the machine is designed additionally to have an analysis unit for analyzing the data collected by the provider unit, using the data from the various levels of the machine.

The provider unit is advantageously designed to provide the mobile data-display device with the collected data and/or the data analyzed by the analysis unit.

It is possible that the electrical controller is connected to at least one element of the machine in a machine-internal communications network in which each communications node is associated with a fixed network address, and wherein the provider unit can provide the data in association with the fixed network address.

It is also possible that the provider unit is designed to provide the data when the mobile data-display device requests the data with specification of the fixed network address.

The machine may be an automation facility in which a manufacturing process for a product or a work procedure runs in an automated manner.

In addition, the machine may comprise near-field sensor technology or a code in order to display using the mobile device, data relating to the status of the at least one machine and/or of at least one of the elements belonging to the machine and controlled by the electrical controller of a machine.

At the machine, the code can be represented on the machine (20) in a stationary manner, or can be mounted on the machine as a printed code, or can be mounted in the vicinity of the machine element concerned, or can be represented dynamically on a display device, in particular as a representation on a display of the central unit, in particular at the request of an operator, or can be a QR code, a barcode or a Data Matrix code.

Preferably, the machine or automation facility, the status of which is to be monitored, is part of a system for monitoring a status. The system may comprise more than one such machine and can additionally comprise a mobile device for displaying data relating to the status of the at least one machine and/or of at least one of the elements belonging to the machine and controlled by the electrical controller of a machine.

The object is also achieved by a computer program product for a data-display device as described herein. The computer program product comprises the following steps: receiving identification data of at least one machine and/or of at least one element belonging to the machine and controlled by an electrical controller of a machine; using the received identification data to request from a provider unit of the at least one machine via a wireless communications link, data relating to the status of the machine and/or of at least one element belonging to the machine and controlled by the electrical controller of the machine; reading and displaying in real time on a display device of the mobile data-display device, the data received as a result of the request.

The computer program product offers the same advantages as previously mentioned with regard to the machine. Moreover, in addition to the local display of individual machines and the elements thereof and the grouping together of status information across different levels of a single machine, a global display of a plurality of machines is also possible.

When executing the computer program product on the mobile data-display device, the step can additionally be executed of assigning the received identification data to a data set relating to the machine type and/or at least one type of the element belonging to the machine and controlled by the electrical controller of the machine.

When executing the computer program product on the mobile data-display device, in the receiving step, the mobile data-display device can be used to read out a code, or near-field sensor technology can be used. Hence the machine enables the use of near-field mechanisms. This means that a display using a suitable device such as, for instance, a smartphone, a tablet PC etc. is possible once the device is located within a certain radius of the machine element for which the status is intended to be displayed. This makes manual register control at the machine unnecessary. In this case, by near-field mechanisms, automatic register control at the machine can be achieved without entering a network address, in particular an IP address. Thus the display can also be quicker. In addition, no contact is needed between the device such as, for instance, a smartphone, a tablet PC etc. and the machine element for which the status is intended to be displayed.

The computer program described above can be installed on a mobile device that is used to display data relating to the status of at least one machine.

Furthermore, the code can be provided on the machine or on the central unit.

In addition, the object is achieved by a method for monitoring the status of at least one machine and/or of at least one element thereof as described herein. The method comprises the steps: using an electrical controller of the machine to control the at least one machine and/or at least one element thereof, and using a provider unit to provide a mobile data-display device with data relating to the status of the at least one machine and/or of at least one of the elements controlled by the electrical controller,

wherein in response to a request received by means of wireless communication from the mobile data-display device, the provider unit provides the data currently being requested so that the mobile data-display device can read and display the provided data in real time.

The method achieves the same advantages as previously mentioned with regard to the machine.

It is possible that the method also comprises the step of receiving identification data of at least one machine and/or of at least one element belonging to the machine and controlled by an electrical controller of a machine by using the mobile data-display device to read out a code or by using near-field sensor technology.

Further possible implementations of the disclosure also include combinations of features or embodiments described above or below with regard to exemplary embodiments, even if these combinations are not mentioned explicitly. A person skilled in the art will also add individual aspects as improvements or additions to the relevant basic form of the disclosure.

### BRIEF DESCRIPTION OF THE DRAWINGS

The disclosure is described in greater detail below using exemplary embodiments and with reference to the enclosed drawing, in which:

FIG. 1 shows a block diagram of a system comprising a mobile data-display device and a machine according to a first exemplary embodiment;

FIG. 2 shows a schematic diagram of part of a machine communications network of the machine according to the first exemplary embodiment;

FIG. 3 shows a schematic diagram of a method that is carried out in the system according to the first exemplary embodiment;

FIG. 4 shows a representation of a display of the machine status, which representation can be displayed on the mobile data-display device according to the first exemplary embodiment;

FIG. 5 shows a representation of a history curve from monitoring the status of a process value (e.g. a variable or a parameter) of the machine, which representation can be displayed on the mobile data-display device according to the first exemplary embodiment;

FIG. 6 shows a block diagram of a system comprising a mobile device and a machine according to a second exemplary embodiment;

FIG. 7 shows a schematic diagram of a method that is carried out in the system according to the second exemplary embodiment;

FIG. 8 shows a block diagram of a system comprising a mobile data-display device and a machine according to a third exemplary embodiment; and

FIG. 9 shows a schematic diagram of a method that is carried out in the system according to the third exemplary embodiment.

### DETAILED DESCRIPTION

In the figures, elements that are identical or have the same function are denoted by the same reference signs unless otherwise stated.

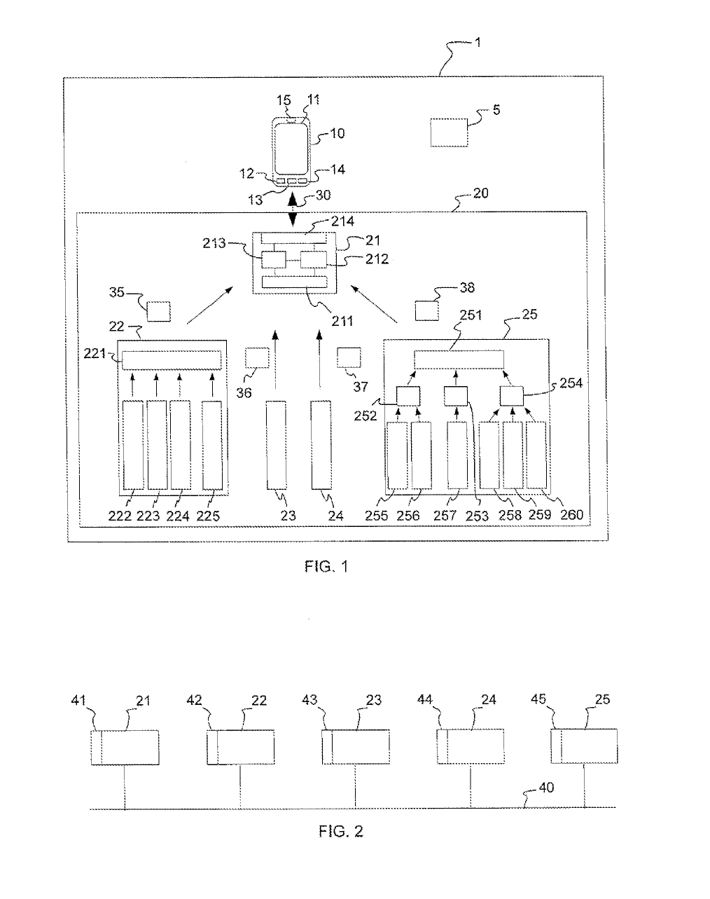

FIG. 1 shows a system 1 in which a product 5 can be manufactured and/or processed. The system 1 has a mobile data-display device 10, which is also referred to below for short as the mobile device 10, and a machine 20. The device 10 and the machine 20 can communicate wirelessly with one another via a communications link 30. The wireless communication via the communications link 30 can be made, for example, by radio or optically, in particular via WLAN, Bluetooth, infrared, etc.

The mobile device 10 has a display device 11, a computer program product 12, a communications device 13, a RAM memory 14 and a reader 15. The display device 11 is used here to display visual signals, for instance in the form of images, and/or to indicate acoustic signals in the form of sounds. In addition to displaying images, the display device 11 can also be used, for example, for acoustic indication of warning messages. The computer program product 12 can also be referred to as an application or app for short. A microprocessor (not shown) of the mobile device 10 can load the computer program product 12 into the RAM memory 14 in order to execute it. The reader 15 is used for reading the data contained in codes 35, 36, 37, 38, i.e. for reading out or decoding the codes 35 to 38. The codes 35 to 38 can each be a barcode, a Data Matrix, a QR code, etc., for example.

The machine 20 has a central unit 21, a first drive unit 22, a first assembly 23, a second assembly 24 and a second drive unit 25. The machine 20 may be a production machine for producing or manufacturing a product, or a machine for performing a work procedure such as, for instance, cleaning an object, heating or cooling an object, positioning an object, etc. The machine may here be an automation facility in which a manufacturing process for a product or a work procedure runs in an automated manner. It is also possible, however, that manufacturing a product and carrying out a work procedure are combined in the machine 20. The machine 20 may be, for example, a processing machine, in particular a packaging machine, printing machine, etc. The machine 20, however, may also be a machine tool such as a CNC machine, a screw-tightening assembly tool, a riveting tool etc. The machine 20 can comprise electrical, hydraulic or pneumatic loads, the status of which can be displayed by the display device 11 of the mobile device 10. For example, at least one of the drive units 22, 25 can be an electrically controlled machine, in particular a motor.

The central unit 21 in this exemplary embodiment comprises a controller 211, a provider unit 212, an analysis unit 213 and a communications device 214. The communications device 214 is used for wireless communication via the communications link 30 with the communications device 13 of the mobile device 10. The wireless communication can be made by radio or optically.

In this exemplary embodiment, the drive unit 22 comprises a drive controller 221, a loading/unloading unit 222, a press unit 223, a handling unit 224 and a screw-tightening assembly unit 225. The individual units 222 to 225 can also comprise sensors, although they are not shown in FIG. 1 in order to simplify the diagram.

The assemblies 23 and 24 can only be switched on or off, with no other means of controlling electrically the status of said assemblies. The assemblies 23 and 24 may be, for instance, a screen, an auxiliary motor for a conveyor belt, a non-controllable hydraulic pump, an actuator, etc.

The drive unit 25 comprises a drive controller 251, to which are connected as subordinate devices a first sub-unit 252, a second sub-unit 253 and a third sub-unit 254. Two final elements 255, 256 are in turn connected as subordinate devices to the first sub-unit 252. A final element 257 is in turn connected as a subordinate device to the second sub-unit 253. Three final elements 258, 259, 260 are in turn connected as subordinate devices to the third sub-unit 254. The sub-units 252, 253, 254 may be, for example, drive mechanisms such as an electric motor, an electrically controlled hydraulic machine, an electrically controlled pneumatic machine etc., which are controlled by the drive controller 251. The individual final elements 255 to 260 may be, for instance, sensors such as a speed sensor, an angle sensor, temperature sensor etc.

The drive units 22, 25, the subordinate elements 221 to 225 and 251 to 260 thereof, and the assemblies 23, 24 are each machine elements or elements of the machine 20.

The controller 211 controls the machine 20 and the respective drive units 22, 25 and hence the subordinate elements 221 to 225 and 251 to 260 thereof, and the assemblies 23, 24. Therefore the controller 211 controls elements of the machine 20. The functions of the provider unit 212 and the analysis unit 213 are described in greater detail later.

The machine 20 in FIG. 1 is thus a machine having an electrical drive-and-control system. For the machine 20, the status can be determined differently according to the type of the machine 20 and the elements 22 to 25, 221 to 225, 251 to 260 thereof. If the drive units 22 are integral drive components, a suitable program can be used to read out the status directly from the drive unit 22 or from the drive controller 221, 251. Hence parameters relating to the status of a drive unit 22, 25 are transferred to the central unit 21 or more precisely to the provider unit 212. For the assemblies 23, 24, it is possible, for instance, to compute in the controller 211 models relating to the status of one of the assemblies 23, 24, or process values (e.g. temperature, operating hours counter etc.) of these assemblies are monitored.

In each case, the condition or status can be determined at the different levels shown in FIG. 1 or at a higher level, i.e. at the level of the central unit 21, at the level of the drive units 22, 25, at the level of the elements 222 to 225 and 252 to 254, at the level of the elements 255 to 260. Hence the condition or status can be determined at a sensor-and-component level, which is below a device level, or at a level lying above all these levels, for example at a server having a built-in database e.g. a generic data server. A web server can additionally lie at a level above said server.

The mobile device 10, or more precisely the computer program product 12 thereof, can optionally receive the condition data directly from one of the elements 255 to 260, for example from a sensor, etc., or from an assigned evaluation unit such as one of the first to third sub-units 252 to 254 or from the controller 251 or from the higher-level central unit 21, in particular from the provider unit 212 or analysis unit 213 thereof.

The status of the machine 20 and the elements 22 to 25, 221 to 225, 251 to 260 thereof with regard to their wear condition or their power consumption can be computed in one of the controllers 211, 221, 251 and then displayed on the display device 11 of the mobile device 10. The wear condition may here comprise relating information, for instance, to availability, the quality that can be achieved for parts to be produced, load cycles etc. The power consumption can be computed and displayed, for instance, in relation to standard operation, etc.

As already mentioned, the resultant data can be collected and processed in the central unit 21. In particular, the data is collected in the provider unit 212 and suitably analyzed and processed in the analysis unit 213.

For instance in this case, the collected data can be compared with the measured value of earlier measurements or compared with an ideal curve or ideal values. The data can then be visualized using the mobile device 10 by transferring the data from the central unit 21 via WLAN and/or the OPC classic interface, OPC/UA interface, etc. (OPC/UA=Open Productivity and Connectivity/Unified Architecture), which may be used in industrial M2M communication (M2M=Machine to Machine), and a high-level language interface, in particular MLPI (MLPI=Motion-Logic Programming Interface), NCS (numerical control interface), real-time interface for CNC control systems. Alternatively, intelligent processing or further processing of the data can take place in the computer program product 12 of the mobile device 10.

Since the machine 20 is composed of a multiplicity of elements such as sensors, evaluation devices, components, devices and mechanisms, it is worth grouping together numerous different items of status information across different levels. In addition for the machine 20, various measurement runs and analysis techniques such as frequency response analysis, friction curves, stiffness analysis etc. are used for the analysis. Therefore it is worth grouping together status information, which can sometimes comprise hundreds of items of status information, across different levels and displaying the status of the machine 20 in a simple manner without an operator of the machine 20 losing the overview. The particular aim is that the operator shall be able to identify easily when necessary the faulty element of the machine 20.

In this exemplary embodiment, the mobile device 10 can be connected by the computer program product 12 to the machine 20 or to one of the elements 21 to 25, 221 to 225, 251 to 260 thereof, and can read out and visualize locally in real time the conditions or status that currently exist. The status can be displayed here for any number of elements 21 to 25, 221 to 225, 251 to 260. The mobile device 10 is likewise able to form sub-assemblies and to display the status of said sub-assemblies live, i.e. in real time. In addition to the wear condition, it is also possible to use the same means to display the availability status or the power consumption status of the elements 21 to 25, 221 to 225, 251 to 260 or the process status of the machine 20, for example how far the production or processing of a workpiece has progressed for the manufacture of the product 5.

Real time in this sense means that the status and condition data is read out and visualized using a time span acceptable to the system 1. The time span lies approximately in the range in which conditions change in the system 1. The time span may lie in the region of milliseconds, for instance, depending on the system.

FIG. 2 shows a machine communications network 40, to which are connected the central unit 21, the drive units 22, 25 and the assemblies 23, 24. A similar communications network exists at the level of the elements 221 to 225 and 251 to 254 and at the level of the elements 255 to 260, even though this is not shown here separately.

In FIG. 2, the central unit 21, the drive units 22, 25 and the assemblies 23, 24 are connected to the machine communications network 40. For the purpose of identifying the individual communications nodes such as the central unit 21, the drive units 22, 25 and the assemblies 23, 24 etc., each communications node has a fixed network address. In FIG. 2, the central unit 21 has a first fixed network address 41. The drive unit 22 has a second fixed network address 42. The assembly 23 has a third fixed network address 43. The assembly 24 has a fourth fixed network address 44. The drive unit 25 has a fifth fixed network address 45. The other components or elements of the machine 20 that are shown in FIG. 1 likewise have a fixed network address in their respective communications network 40, or the data is collected from a node having a fixed network address, even though these nodes are not each shown in FIG. 2. The elements need not necessarily have a fixed network address, however. For example, according to a modification of the configuration described above, an output from the assembly 23 or from a drive unit 22, 25 etc. can be evaluated via an analog input of the controller.

The fixed network addresses 41 to 45 can be mounted on the drive units 22, 25 and the assemblies 23, 24 in the form of the codes 35 to 38 such that they can be read by the mobile device 10. The central unit 21 and the other elements of the machine 20 can each have a code, even though this is not shown in FIG. 1. If the mobile device 10, using the computer program product 12 and/or the reader 15 and one of the codes 35 to 38, reads in a fixed network address, then identification data for the machine 20 or the respective machine element 21 to 25, 221 to 225, 251 to 260 is available to the mobile device. The computer program product 12 can use this identification data to request from the machine 20 and more precisely from the provider unit 212 thereof or from the drive controllers 221, 251 etc. data about the status of the machine 20 or the respective machine element 21 to 25, 221 to 225, 251 to 260 that is identified by the identification data.

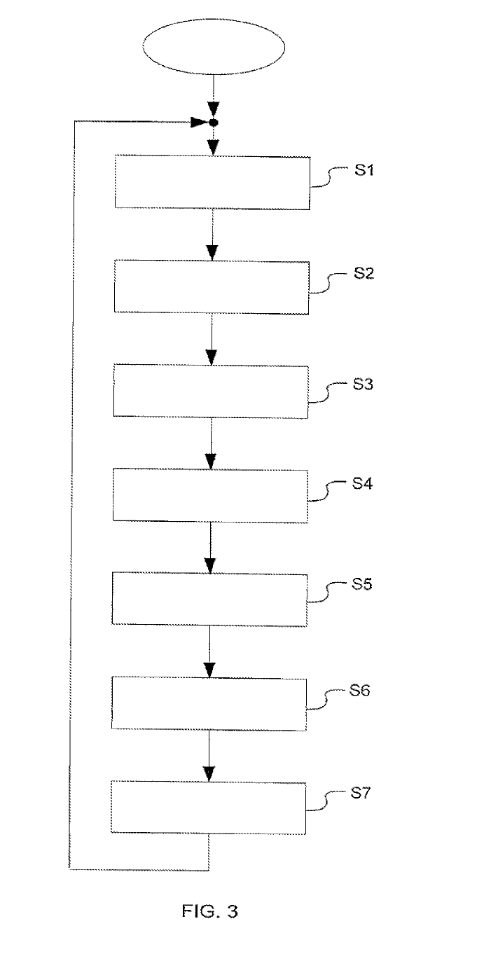

FIG. 3 shows a method that is carried out in the system 1 for monitoring the status of the machine 20 and/or at least of the central unit 21, of one of the drive units 22, 25 and/or of assemblies 23, 24 or of one of the other elements of the machine 20.

After the method is started, in a step S1, the machine 20 and/or one of its elements 21 to 25, 221 to 225, 251 to 260 is controlled by the electrical controller 211 and/or by the drive controllers 221, 251 of the machine 20. In addition, the computer program product 12 can be started on the mobile device 10. The computer program product 12 can also be started later, however. Then the method flow proceeds to a step S2.

In the step S2, the provider unit 212 and/or a comparable unit in the drive units 22, 25 and/or assemblies 23, 24 provide the mobile device 10 with data relating to the status of the machine 20 and/or at least one of the elements controlled by the electrical controller 211 and/or by the drive controllers 221, 251. In this step, the provider unit 212 can provide the data in particular continually or also only intermittently, in particular each time a predetermined time period elapses. The provider unit 212 can store the data, for instance. Then the method flow proceeds to a step S3.

In the step S3, the data provided by the provider unit 212 can be analyzed in the analysis unit 213.

In this step, as already mentioned above, the status to be displayed can be computed, for example, from the numerous different items of status information across different levels. Then the method flow proceeds to a step S4.

In the step S4, by reading out one of the codes 35 to 38, the mobile device 10 receives identification data of the machine 20 and/or of at least one element controlled by the electrical controller 211 of the machine 20 and/or by the drive controllers 221, 251. In this exemplary embodiment, the identification data is the network address 41 to 45 of one of the elements 21 to 25, 221 to 225, 251 to 260. In this step, the received or read-in identification data is assigned to a data set relating to the machine type and/or at least one type of the element belonging to the machine 20 and controlled by the electrical controller 211 of the machine 20 and/or by the drive controllers 221, 251. Then the method flow proceeds to a step S5.

In the step S5, the mobile device 10 requests via the communications link 30 from the provider unit 212 and/or the analysis unit 213 and/or a comparable unit in the drive controllers 221, 251, the data relating to the status of the machine 20 and/or of at least one element belonging to the machine 20 and controlled by the electrical controller 211 of the machine 20 and/or by the drive controllers 221, 251, the identification data of which element and/or machine 20 was received in step S4. Then the method flow proceeds to a step S6.

In the step S6, in response to the request received in step S5 from the mobile data-display device 10 by means of the wireless communication, the provider unit 212 and/or the analysis unit 213 and/or a comparable unit in the drive controllers 221, 251 provide(s) the data currently being requested. In this step, the data is provided such that the mobile data-display device 10 can read and display the provided data in real time. Then the method flow proceeds to a step S7.

In the step S7, the data requested in the step S5 from the provider unit 212 and/or the analysis unit 213 and/or a comparable unit in the drive controllers 221, 251 is displayed in real time on the display device 11 of the mobile device 10. If applicable, a warning message is output by the acoustic indication device 14. Then the method flow returns to the step S1.

The method is at least partially completed if the machine 20 is switched off and/or execution of the computer program product 12 on the mobile device 10 is stopped.

Hence if in the step S1 or later, the computer program product 12 is loaded into the RAM memory 14 of the mobile device 10, once it is loaded, the preceding steps S4, S5 and S7 can be performed by the mobile device 10.

The mobile device 10 can hence be connected by means of the computer program product 12 to the central unit 21, for example, which may be a control system and/or drive system, as previously described.

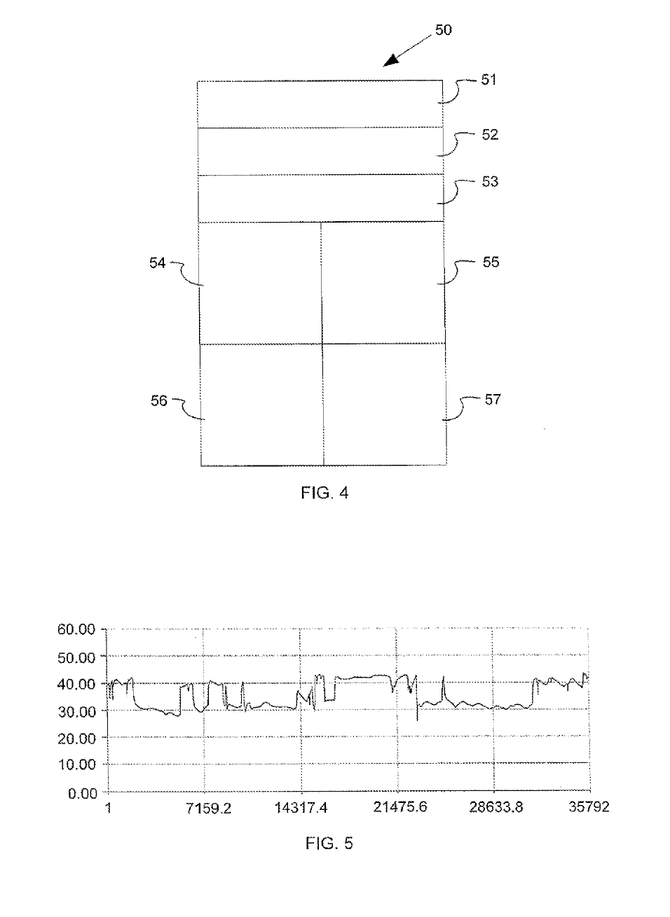

FIG. 4 shows an example of a display on the display device 11 of the mobile device 10 for a case in which the status of the drive unit 22 is displayed, in particular for the loading/unloading unit 222, the press unit 223, the handling unit 224 and the screw-tightening assembly unit 225 thereof. In this case, for example, status information about the mobile device 10, such as time of day, connection to a communications network etc., is displayed in a display segment 51. The name of the computer program product 12 and function buttons such as Next or Back are displayed, for example, in a display segment 52. The name of the system 1 or of the machine 20 is displayed, for example, in a display segment 53. A function button for the loading/unloading unit 222 is displayed, for example, in a display segment 54. A function button for the press unit 223 is displayed, for example, in a display segment 55. A function button for the handling unit 224 is displayed, for example, in a display segment 56. A function button for the screw-tightening assembly unit 225 is displayed, for example, in a display segment 57.

The display segments 54 to 57 form function buttons that can be actuated by the user of the mobile device 10 in order to get the display device 11 of the mobile device 10 to display the status of the drive controller 221 at the level above the elements 222 to 224, i.e. at the level of the central unit 21. The display segments 54 to 57 can also be actuated such that the user can get the display device 11 of the mobile device 10 to display the status of one of the sensors (not shown) or other components at the level below the elements 222 to 224.

For better visualization, the display segments 54 to 57 can display the respective status of the elements 222 to 224 in different colors as defined in the following table according to the VDAM recommendation.

TABLE 1

| | Numeric | | |
|---|---|---|---|
| Bit coding | value | Color | Status |
| 1000 0010 | 82 | red | |
| | | | L3 High |
| 0100 0010 | 42 | orange | |
| | | | L2 High |
| 0010 0010 | 22 | yellow | |
| | | | L1 High |
| 0001 0000 | 10 | green | |
| | | | L1 Low |
| 0010 0001 | 21 | yellow | |
| | | | L2 Low |
| 0100 0001 | 41 | orange | |
| | | | L3 Low |
| 1000 0001 | 81 | red | |
| 0000 1000 | 08 | gray | No status indication |
| 0000 0100 | 04 | white | Manufacturer-specific |

Here, above “L3 High” means that an upper limit is exceeded, and a defect or fault exists; between “L3 High” and “L2 High”, an upper limit is exceeded and a critical condition exists; between “L2 High” and “L1 High”, an upper limit is exceeded and a warning exists; between “L1 High” and “L1 Low”, the status is good;

between “L1 Low” and “L2 Low”, a lower limit is exceeded and a warning exists; between “L2 Low” and “L3 Low”, a lower limit is exceeded and a critical condition exists; below “L3 Low” means that an upper limit is exceeded, and a defect or fault exists.

Using these colors or the bit coding thereof, the highest number is transferred to the next higher level in the machine 20, until finally at the topmost level, for example at the system or machine level, only one display segment of the display segments 54 to 57, one tile, still remains and represents the overall status of all the elements of the machine 10 that lie below this level.

For example, the status of the drive unit 22, which can also be referred to as press, is in turn composed of the status of the controller (not shown) and a drive (not shown) that are located in the press unit 223. The drive status at the next lower level is in turn composed of a plurality of monitoring groups such as temperature monitoring, operating hours counter, error counter and of a plurality of techniques such as friction curve, vibration analysis, stiffness analysis. In this case, a group relating to temperature monitoring, for instance, is in turn subdivided into motor temperature and amplifier temperature.

FIG. 5 shows an example of a display that is displayed on the display device 11 of the mobile device 10 for a sensor (not shown) at the level below the elements 222 to 224 when the function button formed by one of the display segments 54 to 57 is actuated appropriately. Hence in such a case, the history curve of the measurement made by the sensor can be shown, if applicable including relevant limits. This representation has proved especially advantageous in particular if a very sharp rise in the characteristic value occurs within a short time period.

The user of the mobile device 10 can use the representation shown in FIG. 5 to detect peaks in the history curve. In addition, the computer program product 12 can also detect if defined limits are exceeded, and optionally send warning messages, information by SMS etc. to defined users so that these users can respond to changes in condition. The changes in condition detected by the computer program product 12 are additionally processed in accordance with Table 1 shown above to produce the colors for the display of the display segments 54 to 57 in FIG. 4.

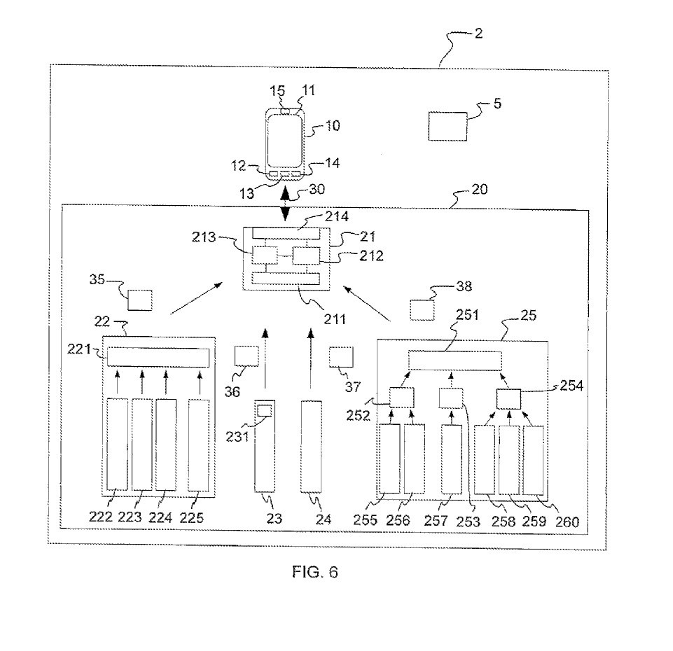

FIG. 6 shows a system 2 comprising a mobile device 10 and a machine 20 according to a second exemplary embodiment. The system 2 largely has the same design and function as the system 1 according to the previous exemplary embodiments. Therefore only the differences from the previous exemplary embodiments are described below.

In this exemplary embodiment, at least the assembly 23 is equipped with near-field sensor technology 231. Using the near-field sensor technology 231, the particular status of the assembly 23 located in the immediate vicinity is displayed to a user if the user comes within the range of the near-field sensor technology 231 of the assembly 23 or passes said technology. In this case, near-field sensor technology means a sensor technology that enables the use of the mobile device 10 to detect the assembly 23 or the identification data thereof in a range of approximately 0.01 m to 20 m, for example in a range of approximately 3 to 10 m for the assembly 23, in particular in front of or around said assembly. The near-field sensor technology 231 can be implemented in particular by means of RFID technology (RFID=Radio Frequency IDentification). Other technologies are also possible for the near-field sensor technology 231 however.

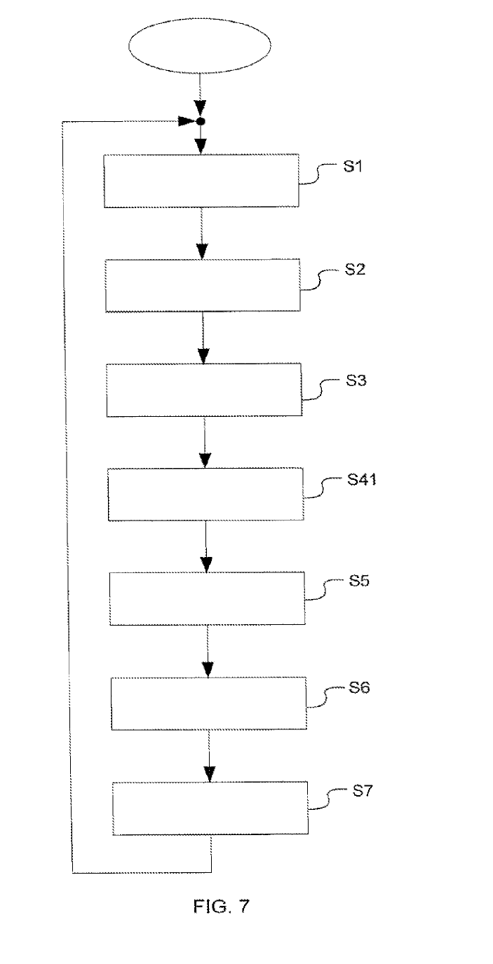

FIG. 7 shows a method that is carried out in the system 2 for this exemplary embodiment. Thus in the system 2, a step S41 is carried out instead of the step S4 in the previous exemplary embodiments.

In the step S41, the near-field sensor technology 231 is used to receive identification data of the machine 20 and/or of at least one element belonging to the machine 20 and controlled by the electrical controller 211 of the machine 20 and/or by one of the drive controllers 221, 251. The method carried out in the system 2 is otherwise identical to the method carried out in the system 1 according to the previous exemplary embodiment.

Hence a user can move freely with the mobile device 10 in a production hall. For complete freedom, all elements of the machine 20 are preferably equipped with near-field sensor technology 231. Thus only one mobile device 10 is required inside a production hall to display the status of the entire machine 20.

Optionally, the mobile device 10 displays all the elements of the machine 20 that are located within the range given by near-field sensor technology. The user of the mobile device 10 can then select the element of the machine 20 that the user wants to connect to or the module or elements of the machine 20 from which the user wants to visualize data. Optionally, the computer program product 12 can also be designed such that the strength of the connection to the respective element of the machine 20 is also displayed on the display device 11. The user of the mobile device 10 can infer from this the distance of the individual elements of the machine 20 from the position of the user.

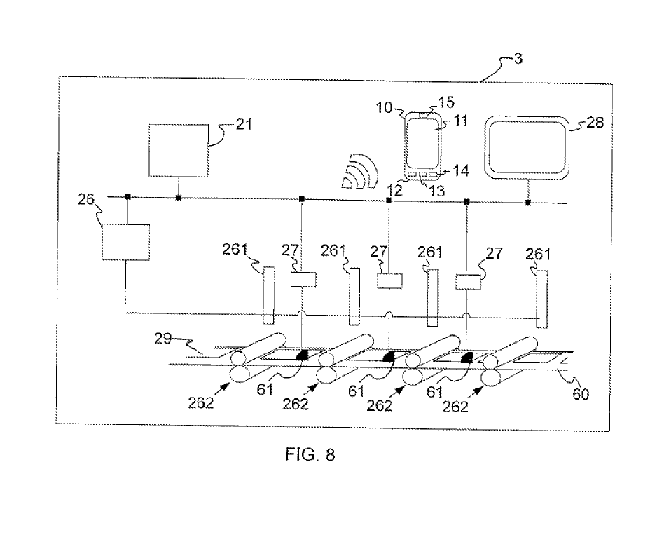

FIG. 8 shows a system 3 comprising a mobile device 10 and a machine 20 according to a third exemplary embodiment. The system 3 largely has the same design and function as the system 1 according to the previous exemplary embodiments. Therefore only the differences from the previous exemplary embodiments are described below.

In this exemplary embodiment, the machine 20 is a web-processing printing machine having a central unit 21, a printing control unit 26, a multiplicity of register control units 27 and a central display device 28, as shown in FIG. 8. The machine 20 prints on a paper web 60 that is provided with register control marks 61. The printing control unit 26 controls a multiplicity of drive controllers 261, which each drive a print mechanism 262. Thus the print mechanism 262 is subordinate to the associated driver controller 261, which in turn is subordinate to the printing control unit 26. The register control units 27 can perform register control. Register control is an additional application and ensures that the colors printed by the printing machine 20 are printed exactly on top of one another on an image 29.

In addition to the mobile device 10, the central display device 28 in FIG. 8 can display data from the system 1 visually and/or indicate said data acoustically. In this case, the central display device 28 can display the data independently of the mobile device 10, i.e. display data other than that displayed on the mobile device 10. The display on the central display device 28, however, can also be coupled to the display on the mobile device 10, so that the central display device 28 and the display device 11 display the same data.

Each of the four print mechanisms 262 shown in FIG. 8 constitute in this exemplary embodiment a local module or element of the machine 20. There can also be more than or fewer than four print mechanisms 262, however, for instance two, ten etc. The distance between the print mechanisms 262 typically equals approximately 0.5 to 5 m. The mobile device 10 can be used to make direct settings for this print mechanism 262 locally, i.e. at the print mechanism 262 itself. For instance, the relevant print mechanism 262 can be opened and reclosed in this case. Since in such an operation, direct local interventions must be made at the print mechanism 262, it is advantageous that these interventions do not have to be made centrally at the location of the central unit 21 but at the location of the machine 20, which the user of the mobile device 10 can choose to suit. In addition to machine operation, the mobile device 10 can be used also to display and operate elements of the register control of the print mechanisms 262 by means of the respective register control device 263, which can also be referred to as local diagnostics.

In this exemplary embodiment, the reader 15 is a camera, in particular a built-in camera, of the mobile device 10. The reader 15 in the form of a camera is used in order to identify the local module for which the data is intended to be displayed, for example the print mechanism 262. A user of the mobile device 10 here uses the reader 15 to photograph the print mechanism 262. The mobile device 10, in particular the computer program product 12 thereof, then determines by means of image analysis the local module or element of the machine 20. Then the mobile device 10 displays on its display device 11 the data from the associated local module, i.e. in this case from one of the print mechanisms 262. In addition, the data from the print mechanism 262 can be displayed on the central display device 28 if it is retrieved by the user or a computer program product (not shown) of the central display device 28.

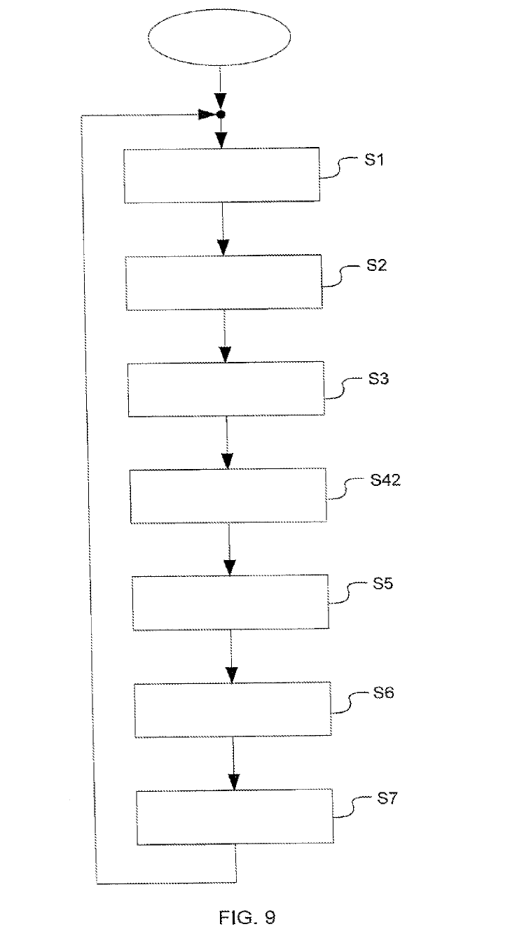

FIG. 9 shows a method that is carried out in the system 3 for this exemplary embodiment. Thus in the system 3, a step S42 is carried out instead of the step S4 or S41 in the previous exemplary embodiments.

In the step S42, the reader 15 in the form of the camera is used to receive the identification data of the machine 20 and/or of at least one element belonging to the machine 20 and controlled by the central unit 21, more precisely by the electrical controller 211 thereof (not shown in FIG. 8) and/or by one of the drive controllers 261, in this case one of the print mechanisms 262. The method carried out in the system 3 is otherwise identical to the method carried out in the system 1 according to the first exemplary embodiment.

This also means that a user can move freely with the mobile device 10 in a production hall and thereby retrieve the data required on the mobile device 10 belonging to the user. Thus only one mobile device 10 is required inside a production hall to display the required data for the entire machine 20.

According to the exemplary embodiments described above, the module or element of the machine 20, the data of which is to be displayed, is determined by various methods as described in the previous exemplary embodiments.

According to the exemplary embodiments described above, status monitoring can be performed at the machine 20 using the mobile device 10 in the form of a smart device such as a smartphone, tablet PC etc. Status monitoring is carried out by the mobile device 10 being connected wirelessly to a control system, drive system or server, as described above. The types of connection can be implemented, for example, using a standardized OPC classic, OPC/UA interface etc. or using a high-level language interface, in particular MLPI, NCS etc.

For all the exemplary embodiments described above, the status data can be displayed in real time locally on the mobile device 10. Alternatively or additionally, the history curve of a subsystem can be visualized on the mobile device 10, as described with reference to FIG. 5.

In all the exemplary embodiments described above, the mobile device 10 can know in advance all the local modules or elements of the machine 20. The mobile device 10 can obtain this information, for example, using a connection to the central unit 21 or by read-out from the central display device 28 of the machine 20. In this case, an interface such as the standardized OPC/UA interface, for instance, or a high-level language interface such as MLPI, for instance, can be used. Optionally, this information can also be generated by the central unit 21 in the form of a dynamic code such as a QR code, Data Matrix code etc., for example, which contains all the active modules or elements of the machine 20. This code is scanned in by the mobile device 10 using the reader 15, for example as the code 35, 36, 37, 38, as described in the first exemplary embodiment, and analyzed by the computer program product 12. The user of the mobile device 10 can now manually specifically select from the active modules or elements of the machine 20 the data, in particular data from a peripheral module, that the user wants to display.

Alternatively, the central unit 21 can also generate and display a code such as a QR code, Data Matrix code etc., for example, which contains information on precisely one of the modules or elements of the machine 20. This code is scanned in by the mobile device 10 using the reader 15, for example as the code 35, 36, 37, 38, as described in the first exemplary embodiment, and analyzed by the computer program product 12. In this case, the user of the mobile device 10 does not need to make any further selection but obtains the required data, i.e. the data specified by the displayed code, displayed on the mobile device 10.

All the embodiments described above of the systems 1, 2, 3 of the mobile device 10, the machine 20 and the method can be used individually or in any possible combinations. In particular, all the features and/or functions of the exemplary embodiments described above can be combined in any way. In addition, the following modifications are possible in particular.

The parts shown in the figures are represented schematically and in the precise embodiment can differ from the forms shown in the figures, provided the above-described functions of said parts are guaranteed.

In an extended embodiment of the disclosure, the computer program product 12 can visualize simultaneously the status of a plurality of machines 20. In such a case, the system 1 or the system 2 or the system 3 has more than one machine 20. Nevertheless, just one mobile device 10 is still used. As described above, the mobile device 10 can communicate with the machine 20 wirelessly again in this case. Hence the mobile device 10 does not need to be connected by cable to the machine 20 for visualization to take place.

As described with reference to the first exemplary embodiment, each of the fixed network addresses 41 to 45 in one of the respective codes 35, 36, 37, 38 in the form of a barcode, a Data Matrix, a QR code etc. can be mounted on the machine and/or the elements thereof such that it can be read by the mobile device 10. This code 35, 36, 37, 38 can contain the IP address which the computer program product 12 uses for connection and then for being able to display the status of the machine. Alternatively, for instance, also just a number assignment can be stored, which the mobile device 10 uses, for example, to read out from the central unit 21 the local data from a local module or element of the machine 20. Optionally, it is likewise possible that each device and/or each part subject to wear of the machine 20 carries this identification. Thus the computer program product 12 can also connect itself to an individual device and/or each part subject to wear of the machine 20, which device or part can be accessed via wireless data transmission (WLAN, Bluetooth, infrared etc.).

The codes 35, 36, 37, 38 do not all have to be of the same type. For instance, the code 35 may be a QR code, whereas the code 36 is a barcode. Any other variants are possible. Hence, for instance, codes can also be used that are present on the devices for entirely different purposes, in particular for production control employing device type and device serial number, etc. This means that an additional code employed solely for topological identification need not be used.

Using the code that has been read out, the mobile device 10 can then make the assignment between code and machine element, for example in a database stored in the central unit 21, in order to transmit data from/to the machine element either directly or via the provider unit 212.

In the methods according to FIG. 3, FIG. 7 and FIG. 9, other method sequences are also possible. For example, the step S3 of analyzing the data can be omitted. The step S3 can also be executed by the computer program product 12 of the mobile device. In addition, it is also possible that the step S3 is executed after the step S4 or the step S5. Alternatively, the step S3 can also be executed in parallel with at least the step S4.

The display segments 54 to 57 in FIG. 4 can be represented solely as colored tiles. Alternatively the display segments 54 to 57 can also show at least one image. Fields in the form of traffic lights can be displayed at the edge of or within the images.

The systems 1 and 2 of the first and second exemplary embodiments can also comprise a central display device 28, as described for the third exemplary embodiment. Alternatively, it is also possible that the system 3 according to the third exemplary embodiment does not comprise a central display device 28.

What is claimed is:

1. A machine comprising:
an electrical controller configured to control the machine and/or at least one element of the machine;
a provider unit configured to provide a mobile data-display device with data relating to a status of the machine and/or a status of the at least one element controlled by the electrical controller; and
a communications device configured to wirelessly communicate with the mobile data-display device,
wherein the provider unit is further configured such that in response to a request received by the communications device from the mobile data-display device, the provider unit provides data currently being requested so that the mobile data-display device can read and display the provided data in real time.

2. The machine according to claim 1, wherein the provider unit is further configured to collect data from different levels of the machine relating to the status of the machine and/or the status of the at least one element controlled by the electrical controller.

3. The machine according to claim 2, further comprising:
an analysis unit configured to analyze the data collected by the provider unit, using the data from the various levels of the machine.

4. The machine according to claim 3, wherein the provider unit is further configured to provide the mobile data-display device with the collected data and/or the data analyzed by the analysis unit.

5. The machine according to claim 1, wherein:
the electrical controller is connected to the at least one element of the machine in a machine-internal communications network in which each communications node is associated with a fixed network address, and
the provider unit is further configured to provide data in association with the fixed network address.

6. The machine according to claim 5, wherein the provider unit is further configured to provide the data when the mobile data-display device requests the data with specification of the fixed network address.

7. The machine according to claim 1, wherein the machine is an automation facility in which a manufacturing process for a product or a work procedure runs in an automated manner.

8. The machine according to claim 1, further comprising:
near-field sensor technology or a code in order to display using the mobile data-display device, data relating to the status of the at least one machine and/or the status of the at least one element belonging to the machine and controlled by the electrical controller.

9. The machine according to claim 8, wherein the code is represented on the machine in a stationary manner, is mounted on the machine as a printed code, is mounted in the vicinity of the machine element concerned, can be represented dynamically as a representation on a display of the central unit at the request of an operator, is a QR code, a barcode, or a Data Matrix code.

10. The machine according to claim 1, wherein:
a system is configured to monitor the status of the machine or the status of an automation facility, and
the system includes the machine and the mobile data-display device configured to display data relating to the status of the machine and/or the status of the at least one element belonging to the machine.

11. A method configured to be executed by a computer program product on a mobile data-display device, the method comprising:
receiving identification data of at least one machine and/or of at least one element belonging to the machine and controlled by an electrical controller of the machine;
using the received identification data to request, from a provider unit of the at least one machine via a wireless communications link, data relating to a status of the machine and/or a status of the at least one element belonging to the machine and controlled by the electrical controller of the machine; and
reading and displaying in real time on a display device of the mobile data-display device, the data received as a result of the request.

12. The method according to claim 11, further comprising:
assigning the received identification data to a data set relating to the machine type and/or at least one type of the at least one element belonging to the machine and controlled by the electrical controller of the machine.

13. The method according to claim 11, wherein in the receiving step, the mobile data-display device is used to read out a code, or near-field sensor technology is used.

14. The method according to claim 11, wherein the code is provided on the machine or on the central unit.

15. The method according to claim 11, wherein:
the mobile data-display device is configured to display data relating to the status of the at least one machine, and
the computer program product is configured to be installed on the mobile data-display device.

16. A method of monitoring a status of at least one machine and/or of at least one element of the machine, comprising:
using an electrical controller to control the at least one machine and/or at least one element of the machine; and
using a provider unit to provide a mobile data-display device with data relating to the status of the at least one machine and/or a status of the at least one element controlled by the electrical controller,
wherein in response to a request received by wireless communication from the mobile data-display device, the provider unit provides the data currently being requested so that the mobile data-display device can read and display the provided data in real time.

17. The method according to claim 16, further comprising:
receiving identification data of the at least one machine and/or of the at least one element belonging to the machine and controlled by an electrical controller of the machine by using the mobile data-display device to read out a code or by using near-field sensor technology.
